(19) United States
(12) Patent Application Publication
(10) Pub. No.: US 2007/0097205 A1
(43) Pub. Date: May 3, 2007

(54) Video transmission over wireless networks

(75) Inventor: Muthaiah Venkatachalam, Beaverton, OR (US)

Correspondence Address: SCHWABE, WILLIAMSON & WYATT, P.C., PACWEST CENTER, SUITE 1900, 1211 S.W. FIFTH AVE., PORTLAND, OR, 97204, US

(73) Assignee: Intel Corporation

(21) Appl. No.: 11/263,759

(22) Filed: Oct. 31, 2005

(51) Int. Cl. H04N 7/14

(52) U.S. Cl. 348/14.02

(57) ABSTRACT

Embodiments of apparatuses, articles, methods, and systems for transmitting video over a wireless network are generally described herein. Other embodiments may be described and claimed.

### FIELD

Embodiments of the present invention relate generally to the field of wireless networks, and more particularly to transmitting/receiving video over such networks.

### BACKGROUND

Wireless networks may include a number of network nodes in wireless communication with one another over a shared medium of the radio spectrum. Transmission of video over these networks, amongst the network nodes, is an increasingly popular application within this technology; however, the real-time, delay-intolerant nature of these transmissions present challenges.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 illustrates a wireless network in accordance with an embodiment of the present invention;

FIG. 2 illustrates a network node for transmitting video over a wireless network in accordance with an embodiment of the present invention;

FIG. 3 illustrates a video sequence in accordance with an embodiment of the present invention;

FIG. 4 illustrates a video transmission in accordance with an embodiment of the present invention;

FIG. 5 illustrates a setting of transfer attributes for a first portion of a video sequence in accordance with an embodiment of the present invention;

FIG. 6 illustrates a setting of transfer attributes for a second portion of a video sequence in accordance with an embodiment of the present invention;

FIG. 7 illustrates a process for transmitting first and second portions of a video sequence in accordance with an embodiment of the present invention;

FIG. 8 illustrates a network node for receiving video over a wireless network in accordance with an embodiment of the present invention;

FIG. 9 illustrates a process of receiving the video sequence in accordance with an embodiment of the present invention; and

FIG. 10 illustrates a video transmitter in accordance with an embodiment of the present invention.

### DETAILED DESCRIPTION

Illustrative embodiments of the present invention may include network nodes to transmit and/or receive video sequences over wireless networks.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific devices and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the present invention; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise.

“comprising,” “having,” and “including” are synonymous, unless the context dictates otherwise.

The phrase “A and/or B” means “(A), (B), or (A and B)”. The phrase “at least one of A, B and C” means “(A), (B), (C), (A and B), (A and C), (B and C) or (A, B and C)”.

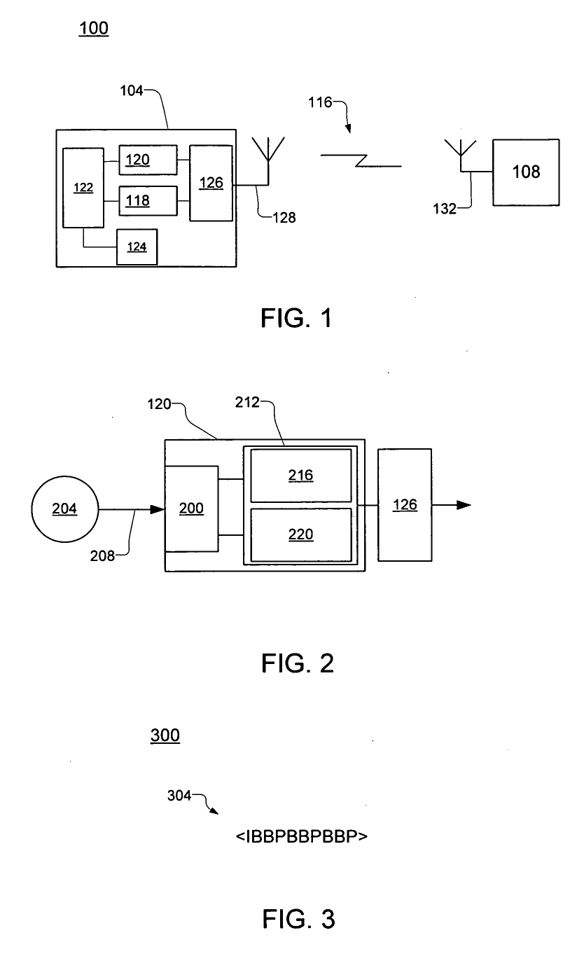

FIG. 1 illustrates a network 100 having network nodes 104 and 108 communicatively coupled to one another via an over-the-air link 116 in accordance with an embodiment of the present invention. The over-the-air link 116 may be a range of frequencies within the radio spectrum, or a subset therein, designated for wireless communication between the nodes of the network 100.

The node 104 may have a receiver 118 and video transmitter 120, which may perform operations of its media access control (MAC) layer. The video transmitter 120 may facilitate the prioritized transmission of constituent portions of a video sequence to the node 108 in accordance with various embodiments of the present invention.

In one embodiment, the receiver 118 and video transmitter 120 may be coupled to a processing device 122, which may be, e.g., a processor, a controller, an application-specific integrated circuit, etc., which, in turn, may be coupled to a storage medium 124. The storage medium 124 may include instructions, which, when executed by the processing device 122, cause the video transmitter 120 to perform various video-transmit operations to be described below in further detail. In various embodiments, the processing device 122 may be a dedicated resource for the video transmitter 120, or it may be a shared resource that is also utilized by other components of the node 104.

Briefly, the video transmitter 120 may communicate a video sequence through a wireless network interface 126 and an antenna structure 128 to the node 108. The wireless network interface 126 may perform the physical layer activities of the node 104 to facilitate the physical transport of the data in a manner to provide effective utilization of the over-the-air link 116.

In various embodiments, the wireless network interface 126 may transmit data using a multi-carrier transmission technique, such as an orthogonal frequency division multiplexing (OFDM) that uses orthogonal subcarriers to transmit information within an assigned spectrum, although the scope of the embodiments of the present invention is not limited in this respect.

The antenna structure 128 may provide the wireless network interface 126 with communicative access to the over-the-air link 116. Likewise, the node 108 may have an antenna structure 132 to facilitate receipt of the video sequence via the over-the-air link 116.

In various embodiments, each of the antenna structures 128 and/or 132 may include one or more directional antennas, which radiate or receive primarily in one direction (e.g., for 120 degrees), cooperatively coupled to one another to provide substantially omnidirectional coverage; or one or more omnidirectional antennas, which radiate or receive equally well in all directions.

In various embodiments, the node 104 and/or node 108 may have one or more transmit and/or receive chains (e.g., a transmitter and/or a receiver and an antenna). For example, in one embodiment, the node 104 may be a multiple-input, multiple-output (MIMO) node, and the video transmitter 120 may include a plurality of transmit chains to perform operations discussed below.

The network 100 may comply with a number of topologies, standards, and/or protocols. In one embodiment, various interactions of the network 100 may be governed by a standard such as one or more of the American National Standards Institute/institute of Electrical and Electronics Engineers (ANSI/IEEE) 802.16 standards (e.g., IEEE 802.16.2-2004 released Mar. 17, 2004) for metropolitan area networks (MANs), along with any updates, revisions, and/or amendments to such. A network, and components involved therein, adhering to one or more of the ANSI/IEEE 802.16 standards may be colloquially referred to as worldwide interoperability for microwave access (WiMAX) network/components. In various embodiments, the network 100 may additionally or alternatively comply with other communication standards such as, but not limited to, those promulgated by the Digital Video Broadcasting Project (DVB) (e.g., Transmission System for Handheld Terminals DVB-H EN 032304 released November 2004, along with any updates, revisions, and/or amendments to such).

The communication shown and described in FIG. 1 may be commonly referred to as a point-to-point communication. However, embodiments of the present invention are not so limited and may apply equally well in other configurations such as, but not limited to, point-to-multipoint.

FIG. 2 illustrates the video transmitter 120 in accordance with an embodiment of the present invention. In this embodiment, the video transmitter 120 may include a classifier 200 to receive a video sequence from a video source 204. The video source 204 may be remotely or locally coupled to the video transmitter 120 over a communication link 208, which may be a wired or wireless link. If the video source 204 is locally coupled to the video transmitter 120, it may be integrated within, or coupled to the node 104. The video source 204 may include a compressor-decompressor (codec) used to compress video image signals, of the video sequence, representative of video pictures into an encoded bitstream for transmission over the communication link 208. Each picture (or frame) may be a still image, or may be a part of a plurality of successive pictures of video signal data that represent a motion video. As used herein, “frames” and “pictures” may interchangeably refer to signals representative of an image as described above.

In some embodiments, the encoded bitstream output from the video source 204 may conform to one or more of the video and audio encoding standards/recommendations promulgated by the International Standards Organization/International Electrotechnical Commission (ISO/IEC) and developed by the Moving Pictures Experts Group (MPEG) such as, but not limited to, MPEG-2 (ISO/IEC 13818 released in 1994, including any updates, revisions and/or amendments to such), and MPEG-4 (ISO/IEC 14496 released in 1998, including any updates, revisions, and/or amendments to such). In some embodiments, the encoded bitstream may additionally/alternatively conform to standards/recommendations from other bodies, e.g., those promulgated by the International Telecommunication Union (ITU).

Some compression standards may use motion estimation techniques to exploit temporal correlations that often exist between consecutive pictures, in which there is a tendency of some objects or image features to move within restricted boundaries from one location to another from picture to picture. For example, consider two consecutive pictures that are identical with the exception of an object moving from a first point to a second point. To transmit these pictures, a transmitting codec may begin by transmitting pixel data on all of the pixels in the first picture to a receiving codec. For the second picture, the transmitting codec may only need to transmit a subset of pixel data along with motion data, e.g., motion vectors and/or pointers, which may be represented with fewer bits than the remaining pixel data. The receiving codec may use this information, along with information about the first picture, to recreate the second picture.

In the above example, the first picture, which may not be based on information from previously transmitted and decoded frames, may be referred to as an intrapicture frame, or an I frame. The second picture which is encoded with motion compensation techniques may be referred to as a predicted frame, or P frame, since the content is at least partially predicted from the content of a previous frame. Both I and P frames may be utilized as a basis for a subsequent picture and may, therefore, be referred to as reference frames. Motion compensated-encoded pictures that do not need to be used as the basis for further motion-compensated pictures may be called “bidirectional,” or B frames.

In various embodiments, the video transmitter 120 may further include a transfer manager 212 having one or more configurators, generally shown as 216 and 220, which are described in detail below.

FIG. 3 illustrates an encoded bitstream of a video sequence 300 in accordance with an embodiment of the present invention. In this embodiment, the video sequence 300 may include a group of pictures (GOP) 304. The GOP 304 may have a number of I, B, and/or P frames. In one embodiment, the GOP 304 may have only one I frame, which may occur at the beginning of the sequence. As discussed above, the I frame may provide a basis, either directly or indirectly, for all of the remaining frames in the GOP 304. If the I frame is not successfully received at the receiving codec, the remaining B and/or P frames may not provide sufficient data to adequately reconstruct the picture sequence represented by the GOP 304. Therefore, in accordance with an embodiment of the present invention, transmission resources may be allocated to reflect a prioritized transfer of selected frames of the GOP 304, e.g., for the I frames.

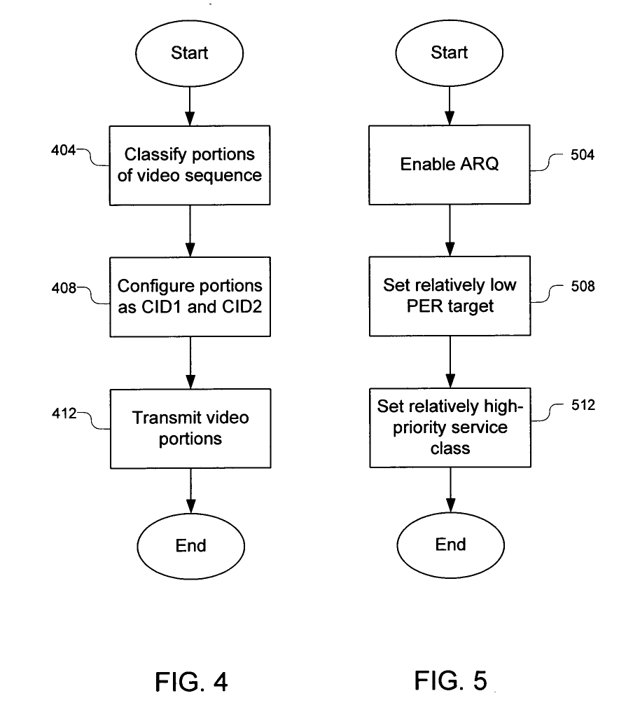

Referring again to FIG. 2 and also to FIG. 4, the video source 204 may communicate the video sequence 300 to the video transmitter 120 over the communication link 208 in accordance with an embodiment of the present invention. The classifier 200 may classify first and second portions of the video sequence 300 (404). References in parentheses may refer to operational phases of the embodiment illustrated in FIG. 4. In this embodiment, the first portion of the video sequence 300 may include the frames selected for prioritized transfer, e.g., the I frames, while the second portion of the video sequence 300 may include frames selected for a standard, or non-prioritized, transfer, e.g., the B and/or P frames.

The video sequence 300 may include a number of GOPs in addition to GOP 304. In some embodiments, the apportionment may be made on a per-GOP basis. For example, in an embodiment the first portion may include the I frames from the GOP 304, while the second portion may include the B and/or P frames from the GOP 304. In some embodiments, apportionment may be made on more than one GOP. For example, the first portion may include the I frames from two GOPs, while the second portion may include the B and/or P frames from the same two GOPs.

In various embodiments, the particular frames of a video sequence may be classified in various ways. For example, in one embodiment, the reoccurring nature of the I frame may be used to identify it in the sequence. In this embodiment, the frame sequence number (FSN) may be referenced to facilitate this identification.

Frames may additionally/alternatively be classified by reference to the payload of the particular frames in accordance with an embodiment of the present invention. A frame's payload may be examined to the extent needed to distinguish between the types of frames. Identification of the frame type may often be found in the bits in the payload that follow the initial protocol identifying bytes. For example, in one embodiment, the first four bytes of a payload may identify that the frame as an MPEG frame and the next few bits may identify the frame as an I, B, or a P frame.

In still another embodiment, the size of a frame may be additionally/alternatively used for classification. For example, an I frame is typically much larger than either a B frame or a P frame. Therefore, in an embodiment frames over a certain size may be assumed to be I frames and classified as the first portion.

Other embodiments may additionally/alternatively use other classification techniques.

The classifier 200 may transmit the I frame and B and/or P frames to the transfer manager 212 as the first and second portions of the video sequence 300. The configurator 216 may assign the I frames a first set of transfer attributes, and the configurator 220 may assign the B and/or P frames a second set of transfer attributes. The varying transfer attributes may reflect the varying priorities of the video portions.

In an embodiment, various components of the network 100 may have connection-oriented MAC layers. These connections may be generally divided into two groups: management connections and transport connections. Management connections may be used to carry management messages, and transport connections may be used to carry other traffic, e.g., user data. The connections may be used to facilitate the routing of information over the network 100.

In an embodiment, the configurator 216 may configure the I frames for transport on a first transport connection identified by a first transport connection identifier, e.g., CID1. Likewise, the second configuration process 220 may configure the B and/or P frames for transport on a second transport connection identified by a second transport connection identifier, e.g., CID2 (408). The configurators 216 and 220 may associate each of the transport connections CID1 and CID2 with its own set of transfer attributes. In various embodiments, these transfer attributes may relate to quality of service (QoS) parameters such as, but not limited to, error protection, bandwidth allocation, and throughput assurances. Mapping a portion of the video sequence 300 to one of these transport connections may therefore also configure the portion with the transfer attributes attributable to the particular connection.

The configurators 216 and 220 may communicate the portions of the video sequence 300 to the wireless network interface 126 for transport via the over-the-air link 116 on CID1 and CID2 (412).

In one embodiment the CIDs may facilitate packet header suppression in addition to facilitating the assignment of transfer attributes. For example, the frames of the video sequence 300 may be transported according to a protocol, such as, but not limited to, real-time transport protocol (RTP), user-datagram protocol (UDP), and/or Internet protocol (IP). The frames assigned to a particular CID may have much of the same information contained in their headers, e.g., source IP address, destination IP address, source port, and/or destination port. Therefore, in an embodiment, the particular CID may be used to uniquely identify the information in the headers that is common to the frames of that particular CID. This may, in turn, reduce the amount of information needed to be transmitted via the over-the-air link 116.

Although the network node 104 is shown above as having several separate functional elements, one or more of the functional elements may be combined and may be implemented by combinations of software configured elements, such as processing elements including digital signal processors (DSPs), and/or other hardware elements. For example, processing elements, such as the processing device 122, may comprise one or more microprocessor, DSPs, application specific integrated circuits (ASICs), and combinations of various hardware and logic circuitry for performing at least the functions described herein.

FIG. 5 illustrates setting transfer attributes for CID1 in accordance with an embodiment of the present invention. In this embodiment, the configurator 216 may enable an automatic retransmission request (ARQ) (504) for the CID1. With ARQ enabled on the CID1, the node 104 may partition the first portion into ARQ blocks; transmit the ARQ blocks over CID1, await acknowledgement of proper receipt from the node 108, and, if acknowledgement is not timely received for one or more ARQ blocks, retransmit those one or more block(s). This may reduce the transmission error over CID1; however, the overhead of the over-the-air link 116 may increase because of retransmissions of the same block(s).

In an embodiment, the configurator 216 may assign the CID1 a packet error rate (PER) target (508). In an embodiment, the configurator 216 may assign a relatively low PER target (e.g., 1%) to the CID1 to reflect the importance of the correctly transferring the I frames. As used herein, and unless otherwise specified, relativity may be in respect to other CIDs such as, for example, CID2.

The configurator 216 may also assign the CID1 a relatively high-priority service class to be used as the basis for bandwidth allocations (512). In an embodiment, network nodes may be two main types: base stations and subscriber stations. For this embodiment, node 108 may be the base station, while node 104 may be a subscriber station. Node 108 may manage access to the over-the-air link 116 between the node 104 and any other node of the network 100 that may timeshare the over-the-link 116. In this embodiment, the node 108 may arbitrate access to the over-the-air link 116 by reference to an assigned service class which could be, for example, an unsolicited grant service (UGS), real-time polling service (rtPS), non-real-time polling service (nrtPS), and best efforts (BE) service.

In an embodiment, the configurator 216 may assign the CID1 a UGS class and the node 108 may allocate bandwidth to the CID1 on a periodic basis without the need for the CID1 to specifically request bandwidth. This may facilitate a reduction in the violation of latency constraints on the transfer of the I frames over the CID1, with the trade-off being that some of the allocated bandwidth may not be fully utilized. Due to the high priority nature of the I frame transmissions, this trade-off may be seen as desirable in this embodiment.

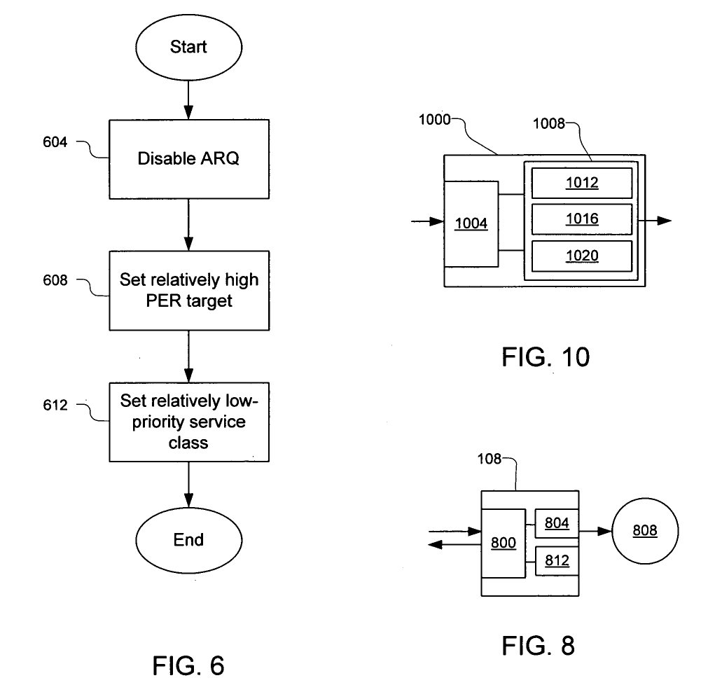

FIG. 6 illustrates a process of setting transfer attributes for CID2 in accordance with an embodiment of the present invention. In this embodiment, the configurator 220 may disable ARQ on CID2 (604). With ARQ disabled the amount of resources required to transmit the B and/or P frames may be reduced, both in terms of computational resources of the node 104 required to partition the second portion of the video sequence 300 into ARQ blocks, and in terms of overhead on the over-the-air link 116 needed for retransmitting the same blocks.

The configurator may assign the CID2 a PER target (608) that may be different than the PER target assigned to CID1. In an embodiment CID2 may be assigned a relatively high PER target (e.g., 15%) which would imply that a higher modulation coding scheme (MCS) could be used, thereby potentially reducing the number of transmission slots used and increasing overall transmission efficiency.

In an embodiment, the configurator 220 may also assign the CID2 a service class that reflects its lower priority, relative to CID1 (612). In an embodiment CID2 may be set with an rtPS class. With reference again to an embodiment where the node 108 is the base station and the node 104 is the subscriber station, the node 104 may issue a specific request for bandwidth on the over-the-air link 116 in response to a polling event. While issuing a specific request for bandwidth may increase the latency and protocol overhead, it may also increase effective utilization of the allocated bandwidth.

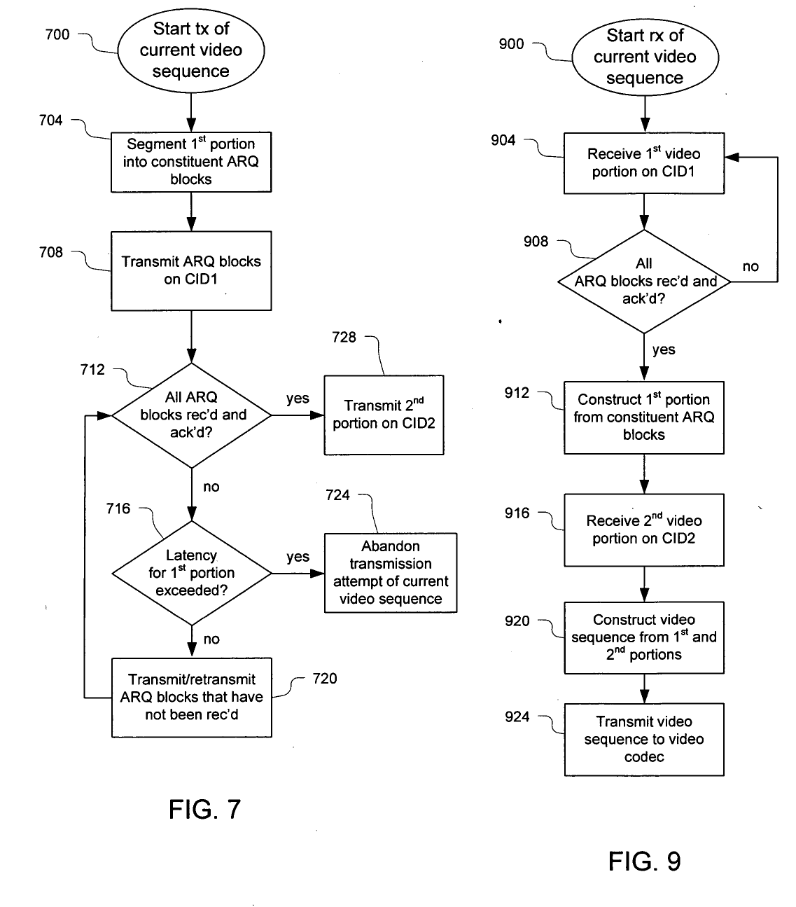

FIG. 7 illustrates a transmission in accordance with an embodiment of the present invention. At the start, the video source 204 may provide a current video sequence to the video transmitter 120 for transmission (700). In this embodiment, the configurator 216 may enable ARQ on CID1 and partition the first portion of the video sequence 300 into ARQ blocks prior to transmission via the over-the-air link 116 (704). Following portioning, the transfer manager 212 may cooperate with the wireless network interface 126 to transmit the ARQ blocks via the over-the-air link 116 (708). After transmission of the ARQ blocks, the node 104 may make a determination whether receipt of all of the ARQ blocks has been properly acknowledged by the node 108 (712). If not, the node 104 may determine whether the latency constraints for the first video portion have been violated (716). If the latency has not been exceeded, then the node 104 may transmit/retransmit the ARQ blocks whose receipt has not been acknowledged (720) and may loop back to phase (712). If the latency constraints have been exceeded, then the transmission attempt of the current video sequence may be abandoned (724).

After the receipt of all of the ARQ blocks has been acknowledged (712), the transfer manager 212 may cooperate with wireless network interface 126 to transfer the second portion of the video sequence 300 on CID2 (728).

FIG. 8 illustrates the node 108 in accordance with an embodiment of the present invention. The node 108 may receive the video sequence 300 transmitted from the node 104 via the over-the-air link 116 with a wireless network interface 800. The wireless network interface 800 may receive the first portion, e.g., the I frames on CID1 and the second portion, e.g., the B and/or P frames, on CID2, and transmit the portions to a video receiver 804. The video receiver 804 may construct the video sequence 300 and transmit it to a receiving codec 808. The receiving codec 808 may decompress the video sequence 300 for playback.

The node 108 may also have a transmitter 812, which, in an embodiment, may be similar to the video transmitter 120 described and discussed above. Likewise, in some embodiments, the receiver 118 may be similar to the video receiver 804.

FIG. 9 illustrates a process for the network node 108 receiving the video sequence in accordance with an embodiment of the present invention. The process may begin with the wireless network interface 800 cooperating with the video receiver 804 to receive a current video sequence (900). The video receiver 804 may receive the ARQ blocks of the first portion of the video sequence 300 on CID1 (904). In response, the transmitter 812 may send various transmissions back to the node 104 acknowledging receipt. Once all of the ARQ blocks have been received and acknowledged (908), the video receiver 804 may reconstruct the first video portion from its constituent blocks (912). The video receiver 804 may then receive the second portion of the video sequence 300 on CID2 (916). With the first and second portions received, the video receiver 804 may construct the video sequence (920) and transfer the constructed video sequence to the receiving codec for decompression and playback (924).

As discussed in the above embodiments, the video sequence 300 may be bifurcated into two portions, e.g., the I frames and the B and/or P frames. In other embodiments the contents of the video sequence 300 may be classified into the first and second portions in different manners. For example, in one embodiment, the first portion may include the I and/or P frames, whereas the second portion may include only the B frames.

In some embodiments, the video sequence 300 may be divided into more than two portions. For example, FIG. 10 illustrates a video transmitter 1000 in accordance with an embodiment of the present invention. The video transmitter 1000 may be substantially interchangeable with the video transmitter 120 described and discussed above. In this embodiment, the video transmitter 1000 may have a classifier 1004 to receive the video sequence 300 and classify first, second, and third portions including the I frames, P frames, and the B frames, respectively. These three portions may be transmitted to a transfer manager 1008. The transfer manager 1008 may have three configurators 1012, 1016, and 1020, to respectively receive the first, second, and third portions of the video sequence 300. The configurator 1012 may map the I frames onto CID1, which may be configured with a first set of transfer attributes. The configurator 1016 may map the P frames onto CID2, which may be configured with a second set of transfer attributes. The configurator 1020 may map the B frames onto CID3, which may be configured with a third set of transfer attributes. The first, second, and third set of transfer attributes may reflect the relative priorities of the frames that are being transmitted in the associated CIDs, e.g., with increasing orders of priorities for the B frames, P frames, and I frames. Although FIG. 10 depicts three configurators within the transfer manager 1008, the methods and apparatuses described herein may include fewer or additional configurators.

In various embodiments, the number of portions that a video sequence may be divided in to, along with the number of corresponding transport connections to which the portions may be mapped to, may correspond to the number of types of video frames used by a particular codec. For example, some embodiments may provide a 1:1 correspondence between video sequence portions (and transport connections) and frame types. In still other embodiments, other ratios may be used, e.g., n:1, 1:n, or m:n, (where m and n are integers greater than 1).

In various embodiments, setting of the transfer attributes may include the setting of additional/alternative attributes than the ones listed and described above. Additionally, the above references to enabling ARQ, setting PER, and setting the service class of a CID may correspond to a particular network's vocabulary, e.g., to a WiMax network; however, embodiments of the present invention are not so limited.

In the above embodiment, the setting of the transfer attributes may be done by configuring the various transport connections; however, other embodiments may configure the transfer attributes of the video portions in other ways.

Embodiments of the present invention allow for the inherent trade-offs between QoS levels and resources required to maintain each of the levels to be separately analyzed and determined for constituent portions of a video sequence. Constituent portions considered to be more important than others may justify an increased amount of resources to provide a higher QoS level. On the other hand, constituent portions of lower importance may be satisfactorily transmitted at a lower QoS level, thereby conserving resources.

Furthermore, teachings of the embodiments described herein may allow for the flexible application of transfer attributes to constituent video portions. In addition to added efficiencies, this may facilitate a wireless network accommodating a variety of traffic including video, voice, and other data, without being constrained to focusing on one to the exclusion of others.

Although the present invention has been described in terms of the above-illustrated embodiments, it will be appreciated by those of ordinary skill in the art that a wide variety of alternate and/or equivalent implementations calculated to achieve the same purposes may be substituted for the specific embodiments shown and described without departing from the scope of the present invention. Those with skill in the art will readily appreciate that the present invention may be implemented in a very wide variety of embodiments. This description is intended to be regarded as illustrative instead of restrictive on embodiments of the present invention.

1. An apparatus comprising:
a video transmitter to receive a video sequence from a video source, to configure a first portion of the video sequence with a first set of transfer attributes, and to configure a second portion of the video sequence with a second set of transfer attributes that is different than the first set; and
a wireless network interface to receive the first and second portions of the video sequence from the video transmitter and to transmit the first and second portions via an over-the-air link.

2. The apparatus of claim 1, wherein the video transmitter configures the first portion of the video sequence for transport on a first transport connection associated with the first set of transfer attributes, and configures the second portion of the video sequence for transport on a second transport connection associated with the second set of transfer attributes.

3. The apparatus of claim 2, wherein the first transport connection is identified by a first transport connection identifier and the second transport connection is identified by a second transport connection identifier.

4. The apparatus of claim 2, wherein the first transport connection is assigned a first service class for access to the over-the-air link and the second transport connection is assigned a second service class for access to the over-the-air link.

5. The apparatus of claim 4, wherein the first service class is an unsolicited grant service (UGS) class and the second service class is a real-time polling service (rtPS) class.

6. The apparatus of claim 2, wherein the video transmitter enables automatic retransmission request (ARQ) on the first transport connection and disables ARQ on the second transport connection.

7. The apparatus of claim 1, wherein the video sequence includes a plurality of frames, each of the plurality of frames having a frame sequence number, and the video transmitter classifies the first and second portions of the video sequence based on at least in part on a frame sequence number of at least a selected one of the plurality of frames.

8. The apparatus of claim 1, wherein the video sequence comprises a group of pictures (GOP).

9. The apparatus of claim 1, wherein the first portion of the video sequence includes an intrapicture (I) frame and the second portion of the video sequence includes a bidirectional (B) picture frame and/or a predicted (P) picture frame.

10. The apparatus of claim 1, wherein the wireless network interface transmits the first portion before the second portion.

11. The apparatus of claim 1, wherein the video transmitter configures a third portion of the video sequence with a third set of attributes, and provides the third portion of the video sequence to the wireless network interface for transmission.

12. The apparatus of claim 1, wherein the video sequence comprises a number of frame types and the video transmitter configures a corresponding number of portions of the video sequence with one or more sets of transfer attributes.

13. A method comprising:
receiving a first portion of a video sequence transmitted via an over-the-air link, the first portion having a first set of transfer attributes; and
receiving a second portion of the video sequence transmitted via an over-the-air link, the second portion having a second set of transfer attributes.

14. The method of claim 13, further comprising:
constructing the video sequence from the first and second portions.

15. The method of claim 13, further comprising:
receiving the first portion of the video sequence on a first transport connection associated with the first set of transfer attributes; and
receiving the second portion of the video sequence on a second transport connection associated with the second set of transfer attributes.

16. The method of claim 13, further comprising:
receiving the first portion of the video sequence before the second portion of the video sequence.

17. The method of claim 13, wherein receiving the first portion of the video sequence includes receiving a plurality of automatic retransmission request (ARQ) blocks, and the method further comprises:
constructing the first portion of the video sequence from one or more ARQ blocks of the plurality of ARQ blocks.

18. An article comprising:
a storage medium; and
instructions stored in the storage medium, which, when executed by a processing device of a network node, cause the processing device to
receive a video sequence from a video source;
configure a first portion of the video sequence with a first set of transfer attributes;
configure a second portion of the video sequence with a second set of transfer attributes that is different than the first set; and
provide the first and second portions of the video sequence to a wireless network interface for transmission via an over-the-air link.

19. The article of claim 18, wherein the instructions, when executed, further cause the processing device to:
configure the first portion of the video sequence for transport on a first transport connection associated with the first set of transfer attributes; and
configure the second portion of the video sequence for transport on a second transport connection associated with the second set of transfer attributes.

20. The article of claim 19, wherein the instructions, when executed, further cause the processing device to:
assign the first transport connection with a first service class as a basis for access to the over-the-air link; and
assign the second transport connection with a second service class as a basis for access to the over-the-air link.

21. The article of claim 18, wherein the video sequence includes a plurality of frames and the instructions, when executed, further cause the processing device to:
classify the plurality of frames into the first and second portions based at least in part on a reference to at least one of a frame sequence number, a payload, and a size of at least one of the plurality of frames.

22. A system comprising:
a video transmitter to receive a video sequence from a video source; to configure a first portion of the video sequence with a first set of transfer attributes; and to configure a second portion of the video sequence with a second set of transfer attributes that is different than the first set;
a wireless network interface to receive the first and second portions of the video sequence from the video transmitter and to transmit the first and second portions via an over-the-air link; and
one or more omnidirectional antennas coupled to the wireless network interface to provide access to the over-the-air link.

23. The system of claim 22, wherein the video transmitter configures the first portion of the video sequence for transport on a first transport connection associated with the first set of transfer attributes, and configures the second portion of the video sequence for transport on a second transport connection associated with the second set of transfer attributes.

24. The system of claim 23, wherein the video transmitter is to:
assign the first transport connection with a first service class for access to the over-the-air link; and
assign the second transport connection with a second service class for access to the over-the-air link.

25. The system of claim 22, wherein the video sequence includes a plurality of frames and the video transmitter is to classify the plurality of frames into the first and second portions based at least in part on a reference to at least one of a frame sequence number, a payload, and a size of at least one of the plurality of frames.

26. A method comprising:
receiving a video sequence;
configuring a first portion of the video sequence with a first set of transfer attributes;
configuring a second portion of the video sequence with a second set of transfer attributes that is different than the first set; and
transmitting the first and second portions of the video sequence via an over-the-air link.

27. The method of claim 26, further comprising:
configuring the first portion of the video sequence for transport on a first transport connection associated with the first set of transfer attributes; and
configuring the second portion of the video sequence for transport on a second transport connection associated with the second set of transfer attributes.

28. The method of claim 27, further comprising:
assigning the first transport connection with a first service class for access to the over-the-air link; and
assigning the second transport connection with a second service class for access to the over-the-air link.

29. The method of claim 26, wherein the video sequence includes a plurality of frames and the method further comprises:
classifying the plurality of frames into the first and second portions based at least in part on a reference to at least one of a frame sequence number, a payload, and a size of at least one of the plurality of frames.

30. The method of claim 26, further comprising:
determining whether receipt of the first portion of the video sequence was acknowledged;
determining whether latency constraints on transmission of the first portion have been violated; and
re-transmitting the first portion and/or transmitting the second portion based at least in part on said determining of whether receipt of the first portion of the video sequence was acknowledged and whether latency constraints on transmission of the first portion have been violated.

31. The apparatus of claim 1, wherein the first set of transfer attributes includes a first packet error rate (PER) target and the second set of transfer attributes includes a second PER target that is higher than the first PER target.
